(19) United States
(12) Patent Application Publication
(10) Pub. No.: US 2014/0316897 A1
(43) Pub. Date: Oct. 23, 2014

(54) LOCATION BASED COMMUNICATION PLATFORM

(71) Applicant: GABSTR, INC., Menlo Park, CA (US)

(72) Inventor: Domingo Martin Barrales Montanaro, Sau Paulo (BR)

(73) Assignee: GABSTR, INC., Menlo Park, CA (US)

(21) Appl. No.: 14/257,210

(22) Filed: Apr. 21, 2014

Related U.S. Application Data
(60) Provisional application No. 61/814,232, filed on Apr. 20, 2013.
(60) Provisional application No. 61/901,965, filed on Nov. 8, 2013.
(60) Provisional application No. 61/912,226, filed on Dec. 5, 2013.
(60) Provisional application No. 61/912,229, filed on Dec. 5, 2013.
(60) Provisional application No. 61/912,234, filed on Dec. 5, 2013.
(60) Provisional application No. 61/912,237, filed on Dec. 5, 2013.
(60) Provisional application No. 61/912,239, filed on Dec. 5, 2013.
(60) Provisional application No. 61/923,940, filed on Jan. 6, 2014.
(60) Provisional application No. 61/923,946, filed on Jan. 6, 2014.

(51) Int. Cl. G06Q 50/00; G06Q 30/02; H04W 4/02

(52) U.S. Cl. CPC G06Q 50/01; H04W 4/023; G06Q 30/0261
USPC 705/14.58; 455/456.3

(57) ABSTRACT

Systems and methods presented herein provide for location based communications. An internet server provides the location based communications to a plurality of user devices. An interface of the server communicatively couples to the user devices through the internet. The server also includes a processor that processes location information received through the interface from a first of the user devices, identifies a set of the plurality of user devices located in a vicinity of the first user device, configures a hub for the first user device that includes the set of user devices, links the hub to an application interface of the first user device, and provides a communication platform between the set of user devices and the first user device based on the hub. The communication platform links each of the user devices in the hub to provide textual communications between the users in the hub.

### CROSS REFERENCE TO RELATED APPLICATIONS

This patent application claims priority to, and is thus entitled to the earlier filing dates of, U.S. Provisional Patent Application Nos. 61/814,232 (filed Apr. 20, 2013), 61/901,965 (filed Nov. 8, 2013), 61/912,226 (filed Dec. 5, 2013), 61/912,229 (filed Dec. 5, 2013), 61/912,234 (filed Dec. 5, 2013), 61/912,237 (filed Dec. 5, 2013), 61/912,239 (filed Dec. 5, 2013), 61/923,940 (filed Jan. 6, 2014), 61/923,946 (filed Jan. 6, 2014), the entire contents of each of which are hereby incorporated by reference.

### FIELD OF THE INVENTION

The invention relates to location based social media.

### BACKGROUND

Location-based systems are enjoying growth in many areas. In particular, location-based services allow users to verify their locations using certain mobile devices, such as smart phones. Some of these services are configured to allow users to use their locations for the purpose of interacting within a social network. For instance, within one type of location-based social network, users are permitted to perform a “check-in” to particular locations, including venues such as businesses, retail locations, points of interest, and/or other locations. Such location-based social networks also permit users to find venues of interest, leave comments regarding particular venues, etc. However, these do not provide any time of real-time communication platform in which users can communicate directly with one another.

### SUMMARY OF THE INVENTION

Systems and methods presented herein provide for location based communications. In one embodiment, an internet server is operable to provide location based communications to a plurality of user devices. The server includes an interface operable to communicatively couple to the user devices through the internet. The server also includes a processor operable to process location information received through the interface from a first of the user devices, to identify a set of the plurality of user devices located in a vicinity of the first user device, to configure a hub for the first user device that includes the set of user devices, to link the hub to an application interface of the first user device, and to provide a communication platform between the set of user devices and the first user device based on the hub. The communication platform is operable to link each of the user devices in the hub to provide real-time textual communications between the users in the hub. These key occasions can also be maintained for later access by users presently in the hub and by users who subsequently become included in the hub.

### BRIEF DESCRIPTION OF THE DRAWINGS

FIG. 1 is a block diagram of an exemplary location based communication system.

FIG. 2 is a flowchart of an exemplary process operable with the communication system of FIG. 1.

FIG. 3 is an exemplary message diagram illustrating inclusion of a user device in a hub.

FIG. 4 is a more detailed block diagram of an exemplary hub generated via the system of FIG. 1.

FIG. 5 is a block diagram of a computing system employing a non-transitory computer readable medium operable to implement various aspects of the location-based social networking system.

### DETAILED DESCRIPTION OF THE DRAWINGS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below.

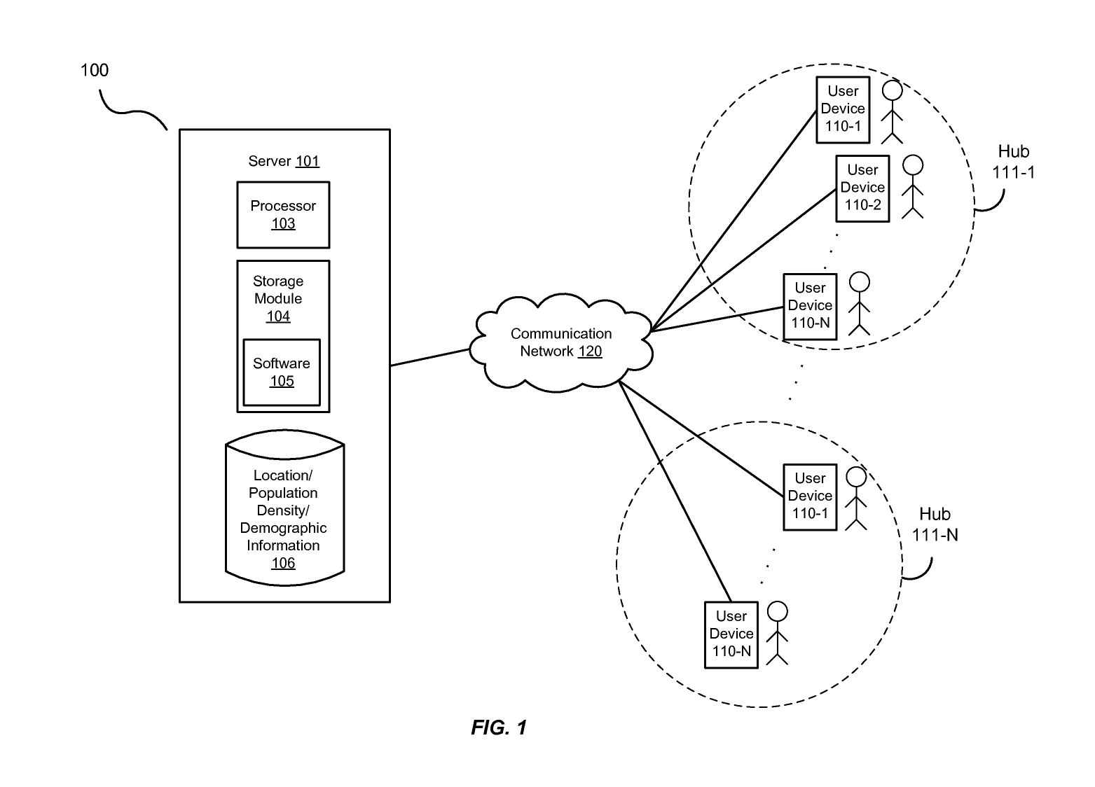

FIG. 1 is a block diagram of a location based communication system 100. The system 100 provides a communications platform for a plurality of user devices 110-1-110-N (where “N” is merely intended to represent an integer greater than “1”). Examples of the user devices 110 include a smart phone, a tablet computer, a desktop computer, a laptop computer, or the like. The system 100 comprises a server 101 that is operable to communicate to the user devices 110 through a communication network 120 such as the Internet. The server 101 includes a processor 103 that is operable to process software 105 within the storage module 104 to implement various aspects hereof. The server 101 also includes a database 106 of location, population density, and/or demographic information that is used to form the hubs 111-1-111-N for the user devices 110. For example, certain parts of the country have higher population densities than other parts of the country. New York City, N.Y. has a population density that is substantially larger than Fargo, N. Dak. As the server 101 is operable to compute hubs 111 based on population density, the server 101 may compute fewer social networking hubs for Fargo than it does for New York City. This helps the user to socially network with more users within the user's immediate location or vicinity. And, once connected in a hub 111, the user is able to immediately communicate with any other user 111 in the same hub.

In one embodiment, a hub 111 may be as small as a single establishment. For example, most mobile/smart phones are configured with Global Positioning System (GPS) receivers. When a user is near a bar or a restaurant and activates an application within the user's smart phone, an application on the user's smart phone may contact the server 101 to convey GPS information of the smart phone to the server 101. Based on that GPS information, the server 101 may determine the precise establishment where the user is located and generate a hub 111 based on that establishment. Based on the hub, the application on the user's device may provide a communication platform from which the user may communicate with other user devices 110 within that bar/restaurant.

It should be noted any type of location information may be used for the hub calculations. For example, the hubs may be created based on a MAC address or even cellular telephony triangulation techniques. It should also be noted that the hubs 111 are not intended to be limited to any particular size or population density. And, the hubs 111 can be dynamically configured based on additional or alternative information such as demographic information. For example, once a user is in a particular location and a hub 111 is already configured for the user at that location, the hub 111 may be dynamically altered based on demographic information associated with the hub 111. The user, in this regard, may input certain demographic information about himself/herself into a user interface of the user device 110 which is processed by the server 101 to alter the size and/or shape of the hub 111 in which the user currently resides such that the user may communicate with others sharing similar demographics.

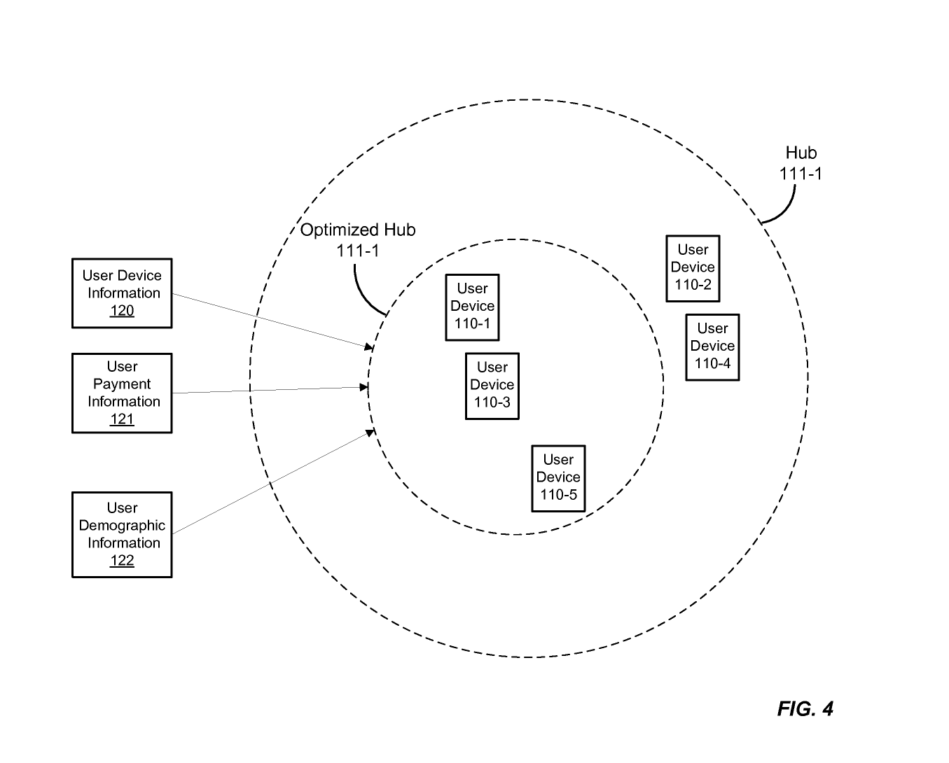

Alternatively or additionally, the hub 111 may be computed or optimized based on information from the user device 110, such as information being entered in the user device 110 by the user. An example of hub 111 optimization is shown and described below in FIG. 4. It should also be noted that the shape of the hub 111, although illustrated herein as a circle, is not intended to be limited to that shape. Generally, other hub shapes may be employed to provide potentially faster of calculations and/or non-overlapping hubs 111 to a user device 110, such as rectangular shaped hubs. In any case, each hub 411 is calculated and configured to represent a substantially real-time “micro community” that allows the users therein to communicate with one another based at least on similar locations to one another.

The hub 111 may also present establishments proximate to a user device 110 within a hub 111 that can be used to optimize the hub. For example, when the user activates an application on the user device 110 that conveys the location information of the user to the server 101, the server 101 may configure a hub 111 for the user device. The server 101 may convey information used to construct that hub 111 to the user device 110, which subsequently presents the hub to the user via a display of the user device 110. The hub 111, in addition to providing a communication platform with other user devices 110, may present a number of establishments located within or proximate to the hub 111. From there, the user may select one of the establishments in the hub 111 that shrinks a size of the hub 111 down to the number of user devices 110 within the establishment. In this regard, the application operable on the user device 110 may present a communication platform to the user that allows the user to communicate with the other user devices 110 within the establishment.

As mentioned, in some embodiments, the location-based communication platform is delivered through an application of the user's device. For example, users may access the communication platform through a communication “app” of a user's smart phone or tablet computing device. Alternatively or additionally, web browsers may employ location based technology allows a user to identify certain establishments in which the hub 111 may be configured. For example, some web browsers employ Google places, Foursquare, etc. that present establishments on a map through the web browser. Accordingly, the invention is not intended to be limited to any particular form of location data to optimize the hubs 111.

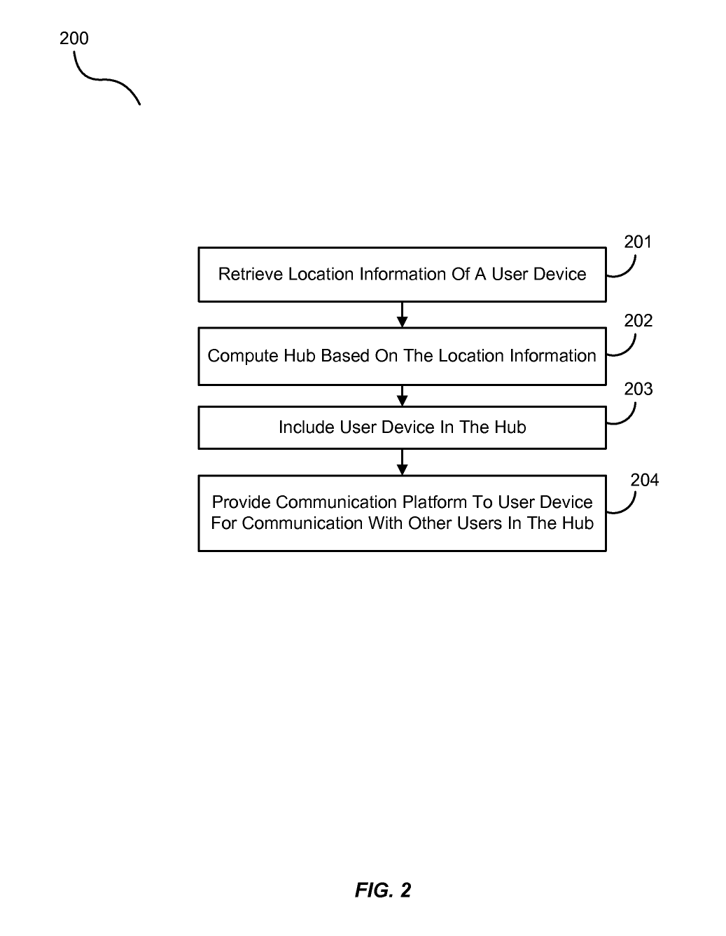

Additionally, the invention is not intended to be limited to any particular number of servers 101, user devices 110 and/or hubs 111. Moreover, the communication system 100 is operable with any type of communication network 120, including the Internet, other data networks, telephone networks, and the like. And, the server 101 is merely intended to represent a computer processing embodiment that allows users to interact with one another. The server 101 may be implemented in a variety of ways as a matter design choice. Additional details regarding the communication system 100 are shown and described in the flowchart of FIG. 2.

FIG. 2 is a flowchart of a process operable with the communication system 100 of FIG. 1. In this embodiment, the server 101 retrieves location information from a user device 110, in the process element 201. For example, when a user of the user device 110 wishes to employ the location based communication features disclosed herein, the user of the user device 110 may initiate an app that directs the user device 110 to transfer GPS information to the server 101. Alternatively, the location information may be based on an IP address of the user device 110. For example, the user device 110 may be communicatively coupled to a Wi-Fi hotspot or other Internet access point in which the location is known.

In any case, the server 101 computes a hub 111 based on the location information of the user device 110, in the process element 202. The server 101 then includes the user device 110 within the hub 111, in the process element 203 and presents information pertaining to the configured hub 111 to the user device 110 to provide a communication platform to the user device, in the process element 204. This allows the user of the user device 110 to communicate with other users also located in the hub (i.e., via their respective user devices 110).

In one embodiment, the hubs 111 are dynamically calculated or otherwise updated. For example, a population density may change relatively fast such as when many people descend on a particular event (e.g., a football game, baseball game, basketball game, etc.). While in the event, a user may wish to communicate with others in the same event. In this regard, the server 101 may recompute a hub so as to provide social networking services to that event. Other examples of events where population densities may change rapidly include disasters and emergencies. For example, when a natural disaster occurs in an area, such as a hurricane in New Orleans, the population of that area tends to shift so as to avoid the natural disaster. The server 101, in this regard, may recompute a hub based on that population shift such that users with their user devices 110 may network to organize relief efforts and the like.

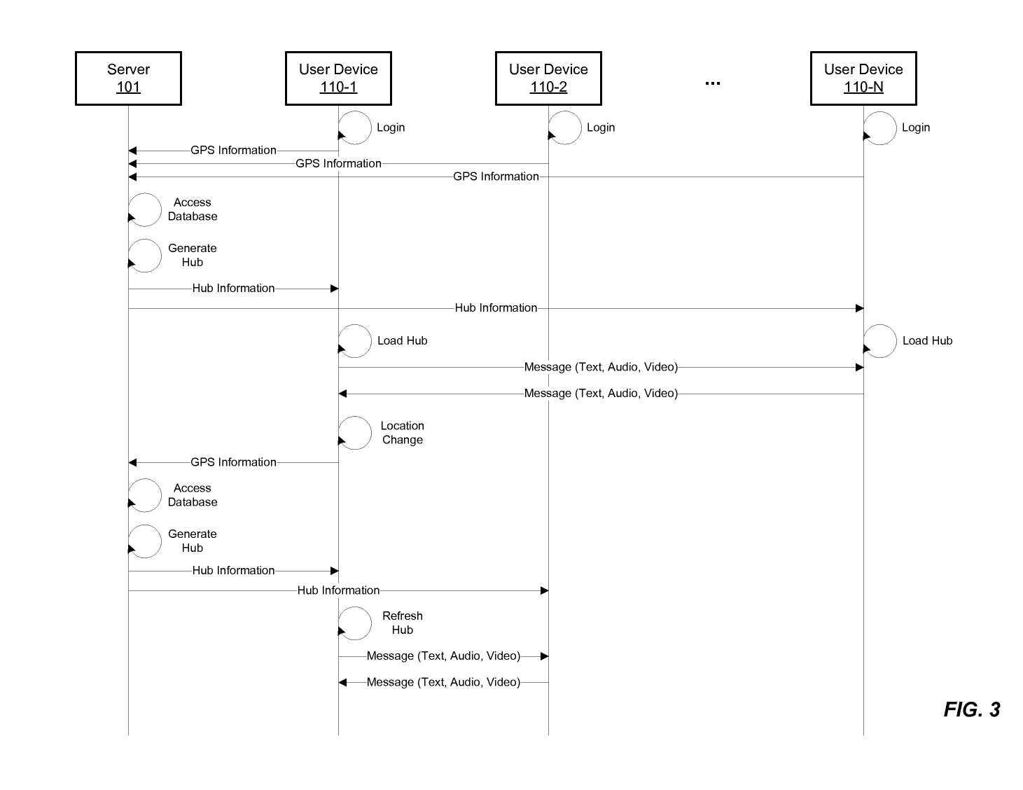

FIG. 3 is an exemplary message diagram illustrating inclusion of one or more of the user devices 110-1-1-N in a hub 111. In this embodiment, the user devices 110-1-110-N login to their respective location based communication platforms as desired. After doing so, the user devices 110 transfer GPS information and/or other location information to the server 101. The server 101 in turn accesses a database to identify where the user devices 110 are geolocated. In this regard, the server 101 may also access information pertaining to the individual users of the user devices 110 including, for example, demographic information, establishment information (e.g., bars, restaurants, businesses, etc., in or near the location of the user device 110), and the like.

Thereafter, the server 101 generates a hub and transfers the hub information to the user devices 110. In this example, the server 101 has identified the user device 110-1 and the user device 110-N as being in the same general vicinity and therefore transfers that particular hub information only to those user devices 110. That is, the hubs 111 are generally hidden from users and less they are in the vicinity of a particular hub. The user devices 110-1 and 110-N then load the hubs 111 such that the user devices can establish a communication platform between users of those devices in the hub to exchange messages including text, audio, and/or video.

Then, to illustrate the dynamic calculation of the hub 111, the user of the user device 110-1 changes locations such that the user device 110-1 is no longer located in the same hub 111 as the user device 110-N. The user device 110-1 then transfers the GPS information and/or other location information to the server 101 which accesses the database to generate another hub 111 for the user device 110-1. The server 101 then conveys the hub information to the user device 110-1 such that the user device 110-1 may load or otherwise refresh the hub 111 presented to the user of the user device 110-1. Similarly, the server 101 may transfer the hub information to the user device 110-2, shown here immediately after the conveyance of the hub information to the user device 110-1 simply for the purposes of illustration. Then, user devices 110-1 and 110-2 can establish a communication platform in which to transfer messages to one another and other user devices within their hub 111.

FIG. 4 is a more detailed block diagram of an exemplary hub 111 generated via the system of FIG. 1. In this embodiment, five user devices 110 were initially configured within the hub 111-1 based on their common/similar locations. If certain users desire a smaller/more intimate communication platform, they may request such from the server 101 through their respective user devices 110. In this regard, the server 101 may employ a variety of factors to decrease the hub size. For example, the user may operate an Internet search engine from the user's user device 110 and enter terms into the search engine. These terms and/or other user device information 120 may be made accessible by the server 101. The server 101 may then use the search terms of the user devices 110-1-110-5 to modify the existing hub 111-1 of user devices 110-1-110-5 to create an optimized hub 111-1 of user devices 110-1, 110-3, and 110-5.

Other examples of information that may be used to optimize the hub 111 include user payment information 121. For example, the user of a device 110 may use a smart phone to make a payment or purchase a product over the Internet (also known as micro-payments). While the billing information of these micro-payments may be blocked or otherwise confidential, information pertaining to the actual purchases may be conveyed to the server 101 such that users may search for user devices 110 making similar payments/purchases and optimize their respective hubs 111. To illustrate, a patron of a bar may make a payment for a beer using a smart phone in a particular hub 111-1. Another user may be searching for a good place to get a beer within the hub 111-1. That user may then search the hub 111-1 looking for micro-payments made to purchase a beer within the hub 111-1 so as to optimize the hub to a smaller number of user devices 110 (e.g., the user devices 110-1, 110-3, and 110-5).

Still other information may include user demographic information 122. For example, a user in the hub 111-1 may be of a particular religion looking for a church in the hub 111-1. That user may search for other user devices 110 within the hub 111-1 to identify other users with similar religious beliefs. The server 101 may then optimize the hub 111 to those users to assist in identifying a church fitting those religious beliefs.

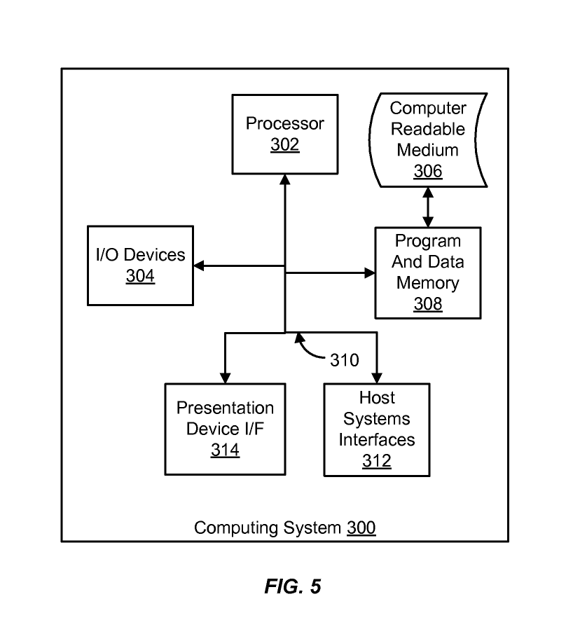

The invention can take the form of an entirely hardware embodiment, an entirely software embodiment, or an embodiment containing both hardware and software elements. In one embodiment, the invention is implemented in software, which includes but is not limited to firmware, resident software, microcode, etc. FIG. 5 illustrates a computing system 300 in which a computer readable medium 306 may provide instructions for performing any of the methods disclosed herein.

Furthermore, the invention can take the form of a computer program product accessible from the computer readable medium 306 providing program code for use by or in connection with a computer or any instruction execution system. For the purposes of this description, the computer readable medium 306 can be any apparatus that can tangibly store the program for use by or in connection with the instruction execution system, apparatus, or device, including the computing system 300.

The medium 306 can be any tangible electronic, magnetic, optical, electromagnetic, infrared, or semiconductor system (or apparatus or device). Examples of a computer readable medium 306 include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The computing system 300, being suitable for storing and/or executing program code, can include one or more processors coupled directly or indirectly to memory 308 through a system bus 310. The memory 308 can include local memory employed during actual execution of the program code, bulk storage, and cache memories, which provide temporary storage of at least some program code in order to reduce the number of times code is retrieved from bulk storage during execution. Input/Output (I/O) devices 304 (including but not limited to keyboards, displays, pointing devices, etc.) can be coupled to the computing system 300 either directly or through intervening I/O controllers. Network adapters may also be coupled to the computing system 300 to enable the computing system 300 to become coupled to other data processing systems, such as through host systems interfaces 312, remote printers, and/or storage devices through intervening private or public networks. Modems, cable modems, and Ethernet cards are just a few of the currently available types of network adapters. The computing system 300 may also include a presentation device interface 314 that allows the computing system to couple to a monitor for video presentation.

Although shown or described with respect to one particular configuration, the invention is not intended be so limited. For example, the server 101 may be representative of multiple servers each being operable to provide the social networking features herein based on location and/or other aspects. Additionally, the invention is not intended to be limited to any of social networking features described herein. In this regard, some non-limiting examples of features for which protection is desired are described in the following provisional claims. Other embodiments and details are shown and described in the attached appendix.

What is claimed is:

1. An internet server operable to provide location based communications to a plurality of user devices, the server comprising:
an interface operable to communicatively couple to the user devices through the internet; and
a processor operable to process location information received through the interface from a first of the user devices, to identify a set of the plurality of user devices located in a vicinity of the first user device, to configure a hub for the first user device that includes the set of user devices, to link the hub to an application interface of the first user device, and to provide a communication platform between the set of user devices and the first user device based on the hub,
wherein the communication platform is operable to link each of the user devices in the hub to provide textual communications between the users in the hub.

2. The internet server of claim 1, wherein:
wherein the communication platform is further operable to link each of the user devices in the hub to provide audio and video communications between the users in the hub.

3. The internet server of claim 1, wherein:
the communication platform is a chat room.

4. The internet server of claim 1, wherein:
the processor is further operable to configure the hub based on a database of public information that identifies establishments in the vicinity of the first user device.

5. The internet server of claim 4, wherein:
the processor is further operable to receive an advertisement for a first of the establishments, and to present the advertisement to the first user device via the communication platform.

6. The internet server of claim 1, wherein:
the processor is further operable to configure the hub based on demographic information of users of the set of user devices and a user of the first user device.

7. The internet server of claim 1, wherein:
the processor is further operable to dynamically update a location of the first user device as the first user device changes locations, and to configure another hub for the first user device based on the updated location of the first user device.

8. The internet server of claim 1, wherein:
the processor is further operable to reconfigure the hub based on a change in a population density.

9. A method of providing location based communications to a plurality of user devices via an internet server, the method, comprising:
communicatively coupling to the user devices through the internet;
processing location information received from a first of the user devices;
identifying a set of the plurality of user devices located in a vicinity of the first user device;
configuring a hub for the first user device that includes the set of user devices;
linking the hub to an application interface of the first user device; and
providing a communication platform between the set of user devices and the first user device based on the hub,
wherein the communication platform is operable to link each of the user devices in the hub to provide textual communications between the users in the hub.

10. The method of claim 9, further comprising:
linking each of the user devices in the hub to provide audio and video communications between the users in the hub.

11. The method of claim 9, wherein:
the communication platform is a chat room.

12. The method of claim 9, further comprising:
configuring the hub based on a database of public information that identifies establishments in the vicinity of the first user device.

13. The method of claim 12, further comprising:
receiving an advertisement for a first of the establishments; and
presenting the advertisement to the first user device via the communication platform.

14. The method of claim 9, further comprising:
configuring the hub based on demographic information of users of the set of user devices and a user of the first user device.

15. The method of claim 9, further comprising:
dynamically updating a location of the first user device as the first user device changes locations; and
configuring another hub for the first user device based on the updated location of the first user device.

16. The method of claim 9, further comprising:
reconfiguring the hub based on a change in a population density.

17. An internet server operable to provide location based communications to a plurality of user devices, the server comprising:
a database of user profiles;
an interface operable to communicatively couple to software applications executed on the user devices through the internet; and
a processor operable to link to a first software application of a first user device through the interface, to process location information received through the interface from the first user device, to retrieve a profile of a user of the first user device from the database, to identify components of the first user profile that correspond at least in part to components of other user profiles in the database, to identify a set of the plurality of user devices located in a vicinity of the first user device, to configure a hub for the first user device based on the user profiles and locations of the user devices, to link the hub to a first software application on the first user device through the internet, and to provide a communication platform for all of the user devices in the hub,
wherein the communication platform is operable to link each of the user devices in the hub to provide textual, audio, and video communications between the users in the hub.
